(19) United States
(12) Patent Application Publication
(10) Pub. No.: US 2008/0115395 A1
(43) Pub. Date: May 22, 2008

(54) Light Emittng Display Body and Display Structure Body

(75) Inventors: Mitsunori Saito, Shiga (JP); Kanji Minamiura, Osaka (JP)

Correspondence Address: THE WEBB LAW FIRM, P.C., 700 KOPPERS BUILDING, 436 SEVENTH AVENUE, PITTSBURGH, PA, 15219, US

(73) Assignee: EZ BRIGHT CORPORATION, Osaka (JP)

(21) Appl. No.: 10/580,095

(22) PCT Filed: Nov. 22, 2004
(86) PCT No.: PCT/JP04/17363

§ 371 Date: Apr. 13, 2007

(30) Foreign Application Priority Data
Nov. 21, 2003 (JP) 2003-431296
Jul. 23, 2004 (JP) 2004-238915
Oct. 13, 2004 (JP) 2004-325687

(51) Int. Cl. G09F 13/04

(52) U.S. Cl. 40/564

(57) ABSTRACT

There is provided a display structure body for escape guide utilizing a light accumulation material which can also be utilized in a normal time in a bright place. The display structure body includes a light transmitting first pattern layer unit having a pattern made by a light accumulation material and a light transmitting second pattern layer unit for normal display, on the surface of a light emitting unit. In a normal time, it has a normal display function such as an advertisement. When power supply is stopped, it is automatically switched to a display of escape guide or the like.

### TECHNICAL FIELD

The present invention relates to a display structure body used in escape guide at the time of the stoppage of power supply.

### RELATED ART

In a disaster at midnight or in a dark place such as a subway or an underground arcade, when power which is always supplied and backup power are disconnected, a display of escape guide is invisible and thus a large disaster may be caused.

In order to cope with such circumferences, recently, displaying of escape guide using a light accumulation material for emitting light in a dark place is accomplished.

Patent Document 1: Japanese Unexamined Patent Application Publication No. 2001-51632

### DISCLOSURE OF THE INVENTION

### Problems that the Invention is to Solve

In displaying of escape guide using a light accumulation material for emitting light in a dark place, in order to enhance safety, a plurality of large-sized displays are preferably provided such that the contents are easily appreciable.

However, the displaying of escape guide does not operate unless power supply is stopped due to the occurrence of a disaster. Thus, the displaying of escape guide is unnecessary in a normal time. In addition, if the display of escape guide is provided in plural, the landscape or design of a subway or an underground arcade is deteriorated.

The present invention has been conceived to solve the above mentioned problems. An object of the present invention is to provide a display structure body for escape guide utilizing a light accumulation material which can also be utilized in a normal time in a bright place. That is, it is possible to provide a display structure body which can display a general advertisement in a normal time and display an indicator for escape guide in an emergency.

### Means for Solving the Problem

According to an aspect of the present invention, there is provided a display structure body including a light transmitting first pattern layer unit having a pattern made by a light accumulation material and a light transmitting second pattern layer unit for normal display, on the surface of a light emitting unit. According to such a display structure body, it has a normal display function such as an advertisement in a normal time. When power supply is stopped, it is automatically switched to a display of escape guide or the like.

According to another aspect of the present invention, there is provided a display structure body including a light transmitting first pattern layer unit having a pattern made by a light accumulation material, a light transmitting second pattern layer unit for normal display, a light transmission restriction layer unit provided between the first pattern layer unit and the second pattern layer unit, and a light emitting unit provided on the second pattern layer unit at the opposite side of the light transmission restriction layer.

By such a display structure body, a pattern for an advertisement of the second pattern layer unit appears on the Surface thereof by the light of the light emitting unit and external light in a bright place. At that time, the pattern of the first pattern layer unit slightly appears, but is unlikely to be distinguished by the pattern of the second pattern layer unit. In a dark place, a display of escape guide appears on the surface thereof by light emitted from the light accumulation material of the first pattern layer unit excited by external light in a normal time. At that time, the light from the first pattern layer unit passes through the light transmission restriction layer unit to reach the second pattern layer unit and the reflected light again passes through the light transmission restriction layer unit to reach the first pattern layer unit. Since the light passes through the light transmission restriction layer unit twice such that the amount of light is reduced (square value of the light transmission of the light transmission restriction layer unit), the pattern of the second pattern layer unit hardly appears on the surface thereof.

According to another aspect of the present invention, there is provided a display structure body including a light transmitting first pattern layer unit having a pattern made by a light accumulation material, a light transmitting second pattern layer unit for normal display, a light transmission restriction layer unit provided between the first pattern layer unit and the second pattern layer unit, and a light emitting unit provided on the second pattern layer unit at the opposite side of the light transmission restriction layer, on a material layer having a short-wavelength light absorption function.

By such a display structure body, a pattern for an advertisement or the like of the second pattern layer unit appears on the surface thereof by the light of the light emitting unit and external light in a bright place. At that time, the pattern of the first pattern layer unit slightly appears, but is unlikely to be distinguished by the pattern of the second pattern layer unit. In a dark place, a display of escape guide appears on the surface thereof by light emitted from the light accumulation material of the first pattern layer unit excited by external light in a normal time. At that time, the light from the first pattern layer unit passes through the light transmission restriction layer unit to reach the second pattern layer unit and the reflected light passes through the light transmission restriction layer unit to reach the first pattern layer unit. Since the light passes through the light transmission restriction layer unit twice such that the amount of light is reduced (square value of the light transmission of the light transmission restriction layer unit), the pattern of the second pattern layer unit hardly appears on the surface thereof The normal excitation of the light accumulation material is realized by the light of the light emitting unit as well as external light. The light from the light emitting unit is influenced by the pattern of the second pattern layer unit because the light passes through the second pattern layer unit. As a result, if the light accumulation material of the first pattern layer unit is not uniformly excited, an irregularity in brightness occurs in the pattern of the first pattern layer unit in a dark place.

Therefore, in this aspect of the present invention, in consideration that the light accumulation material is likely to be excited by light having a wavelength of less than 400 nm such as ultraviolet ray or purple light, an irregularity in brightness is prevented from occurring in the pattern of the first pattern layer unit as follows. That is, a light transmitting layer made of a material for absorbing ultraviolet ray is provided below the pattern made of the light accumulation material of the first pattern layer unit. Accordingly, the light transmitting layer absorbs the ultraviolet ray from the light emitting unit to prevent the ultraviolet ray from reaching the pattern of the light accumulation material and to prevent an irregularity in brightness from occurring in the pattern of the light accumulation material of the first pattern layer unit in a dark place.

According to another aspect of the present invention, there is provided a display structure body including a light transmitting first pattern layer unit having a pattern made by a light accumulation material, a light transmitting second pattern layer unit for normal display, which faces the first pattern layer unit, a light transmission restriction layer unit provided on the first pattern layer unit at the opposite side of the second pattern layer unit, and a light emitting unit provided on light transmission restriction layer at the opposite side of the first pattern layer unit.

By this configuration, in the display structure body, the pattern of the second pattern layer unit appears on the surface thereof by the light of the light emitting unit and external light in a normal time. In a normal time, the light accumulation material included in the first pattern layer unit is excited by the external light and the light of the light emitting unit.

In a normal time, the light of the light emitting unit is blocked to some extent by the light transmission restriction layer unit, but an influence is hardly exerted when a sufficiently bright light source of the light emitting unit is used. In addition, the pattern of the second pattern layer unit becomes clear by the external light as well. The pattern of the first pattern layer unit slightly appears by the light of the light emitting unit, but is hardly distinguished.

When power supply is stopped, the light emission of the display structure body disappears and external light also disappears. At that time, in a dark place, a pattern appears on the surface of the second pattern layer unit by the light emitted from the light accumulation material of the first pattern layer unit which is excited by the external light and the light of the light emitting unit in a normal time.

According to another aspect of the present invention, there is provided a light emitting display body including a light transmitting first pattern layer unit having a pattern made by a light accumulation material and a light transmission restriction layer unit provided on the rear surface of the first pattern layer unit, wherein the light emitting display body is mounted on the surface of an illumination display body.

According to such a light emitting display body, the first pattern layer unit emits light in a dark place and the light transmission restriction layer unit is provided on the rear surface of the first pattern layer unit such that the light from the other side is suppressed from reaching thereto. In addition, a display structure body is configured by mounting the light emitting display body on an illumination display body.

By using the light emitting display body, it is possible to obtain a display structure body which can be easily and efficiently used using an illumination display body such as a conventional illumination advertisement panel both in a dark place and a bright place at low cost.

### Effect of the Invention

According to a display structure body according to the present invention, it has a general display function such as an advertisement in a normal time. When power supply is stopped, it is automatically switched to a display of escape guide or the like.

In the display structure body including a light transmission restriction layer unit according to the present invention, the pattern of the second pattern layer unit is suppressed to appear on the surface thereof in a dark place and thereby the display becomes clear when power supply is stopped, that is, display performance is excellent.

### BRIEF DESCRIPTION OF THE DRAWINGS

FIG. 1 is an outer appearance perspective view showing a display structure body according to embodiments of the present invention.

FIG. 2 is a structural view showing a display structure body according to a first embodiment of the present invention.

FIG. 3 is a pattern view of a first pattern layer unit of the display structure body according to the embodiments of the present invention.

FIG. 4 is a structural view showing a display structure body 1 according to a second embodiment of the present invention.

FIG. 5 is a partial enlarged cross-sectional view showing a display structure body 1 according to a third embodiment of the present invention.

FIG. 6 is a partial enlarged cross-sectional view showing a display structure body 1 according to a fifth embodiment of the present invention.

FIG. 7 is a partial enlarged cross-sectional view showing a display structure body 1 according to a sixth embodiment of the present invention.

FIG. 8 is a partial enlarged cross-sectional view showing a display structure body 1 according to a seventh embodiment of the present invention.

FIG. 9 is an enlarged cross-sectional view showing a first pattern layer unit 2 of the display structure body 1 according to the seventh embodiment of the present invention.

FIG. 10 is a partial enlarged cross-sectional view showing a display structure body 1 according to an eighth embodiment of the present invention.

FIG. 11 is a pattern view showing a first pattern layer unit and a second pattern layer unit of a display structure body 1 according to a ninth embodiment of the present invention.

FIG. 12 is a structural view showing a display structure body 1 according to a tenth embodiment of the present invention.

FIG. 13 is a partial enlarged cross-sectional view showing a display structure body 201 according to an eleventh embodiment of the present invention.

FIG. 14 is a structural view showing a display structure body 1 according to a twelfth embodiment of the present invention.

FIG. 15 is an exploded perspective view showing a display structure body in which a light emitting display body is mounted.

FIG. 16 is a vertical cross-sectional view showing the use state of a display structure body in which a light emitting display body is mounted.

FIG. 17 is an explanatory view showing the display state of a light emitting display body.

### REFERENCE NUMERALS

1: display structure body

2: first pattern layer unit

3: half mirror unit

4: second pattern layer unit

5: light emitting unit

### BEST MODE FOR CARRYING OUT THE INVENTION

A display structure body according to the present invention includes a light transmitting first pattern layer unit having a pattern made by a light accumulation material and a light transmitting second pattern layer unit for normal display, on the surface of a light emitting unit.

Hereinafter, embodiments of the present invention will be described with reference to the accompanying drawings.

### First Embodiment

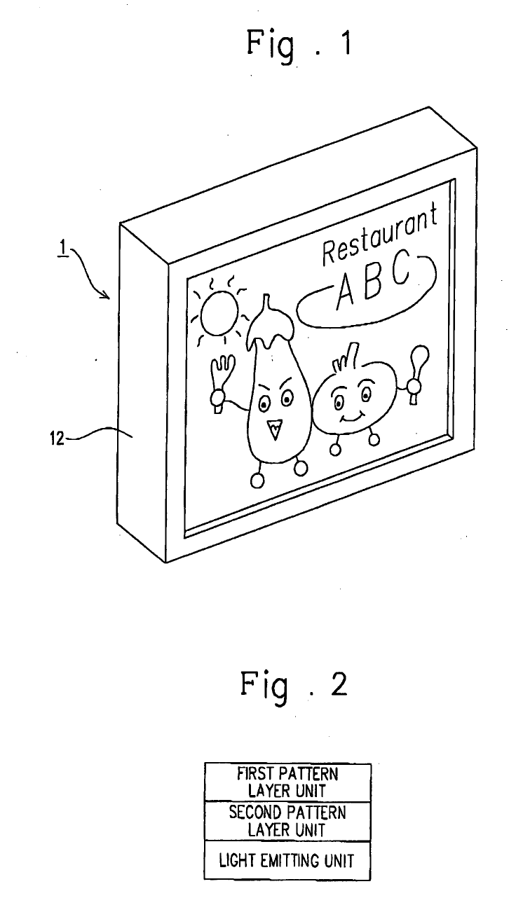

FIG. 1 is an outer appearance perspective view showing a display structure body according to embodiments of the present invention.

FIG. 2 is a structural view showing a display structure body according to a first embodiment of the present invention.

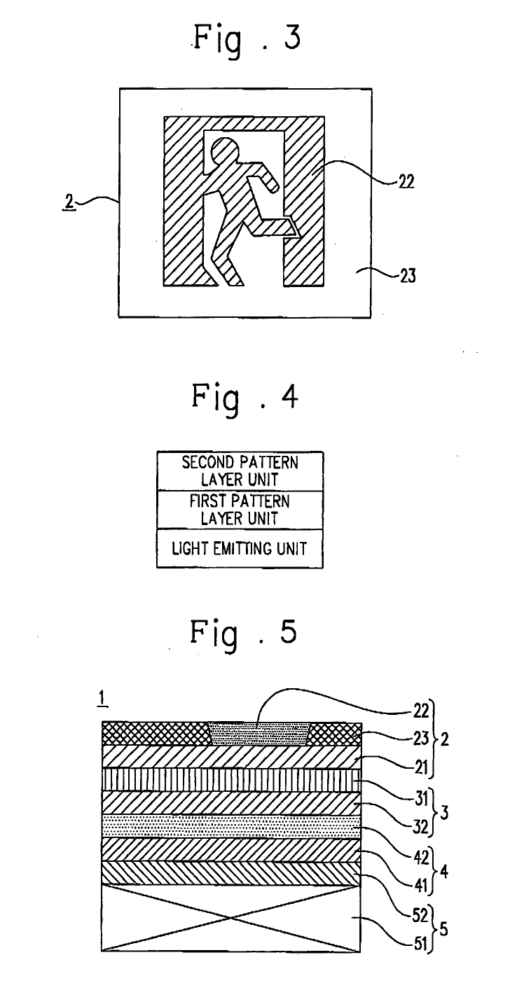

FIG. 3 is a pattern view of a first pattern layer unit of the display structure body according to the embodiments of the present invention.

As shown in FIG. 2, the display structure body 1 includes a light transmitting first pattern layer unit 2 having a pattern made by a light accumulation material, a light transmitting second pattern layer unit 4 for normal display, which faces the first pattern layer unit 2, and a light emitting unit 5 provided on the second pattern layer unit 4 at the opposite side of the first pattern layer unit 2.

As shown in FIG. 3, the first pattern layer unit 2 has a pattern for displaying an exit and the pattern is formed by color separation coating a film made of polyester resin or polycarbonate resin with pigments 22 and 23 mixed with a light accumulation material (white powder) for emitting light of green or blue. The entire surface of the first pattern layer unit 2 is color separation coated with the pigments 22 and 23 mixed with the light accumulation material such that the entire surface is in a white turbidity state. Thus, the pattern is unlikely to be identified in a bright place in a normal time.

Here, the white turbidity state indicates a state that the pattern of the second pattern layer unit is visible in at least a bright place.

The light transmittance of the first pattern layer unit is to transmit at least 20% of the light from a lower layer. The light transmittance is measured by a spectrophotometer C-7473 (measurement wavelength: 550 nm) made by Hamamatsu Photonics K.K.

As the resin of the pigment, 12-hour curing epoxy resin is used. The epoxy resin is mixed with the light accumulation material (white powder) for emitting light of respective colors with a concentration of 15 wt %.

As the pattern formed in the first pattern layer unit 2, for example, only an escape guide mark portion such as an exit or an arrow for indicating an escape direction may be formed with pigments mixed with the light accumulation material or a portion other than the escape guide mark such as the exit or the arrow for indicating the escape direction may be formed with the pigments mixed with the light accumulation material. For example, by forming the portion back space) other than the escape guide mark such as the exit or the arrow for indicating the escape direction with the pigments mixed with the light accumulation material the back space portion is bright. Thus, the escape guide mark is distinguishable. Here, the light accumulation material is powder of a color from white to light pea green and indicates a material which receives solar light or artificial light and emits “phosphorescence” after the light disappears. The light accumulation material may be a mixture of zinc sulfate and copper or a mixture of strontium aluminate and rare earth elements such as europium or dysprosium.

The light accumulation material used in the embodiments is powder of a color from white to light pea green and generally has a particle diameter of 2 to 25 μm. The average particle diameter thereof is measured by a particle size distribution measurement device.

The second pattern layer unit 4 has a pattern for an advertisement shown in FIG. 1 and a colorful pattern is formed on a polyester film 41 by an ink 42 of proper color.

Generally, a surface light emitting lamp covered by a milky white cover 52 and having a fluorescent lamp 51 of brightness of about 1900 cd/m² is used as the light emitting unit 5.

The display structure body 1 is configured in a panel shape by sequentially laminating the second pattern layer unit 4 and the first pattern layer unit 2 on the light emitting unit 5 and fixing the circumferences thereof by a frame 12, and is used in a state that the rear surface thereof is attached to a wall or the like.

The display structure body 1 is used in a state that the fluorescent lamp 51 of the light emitting unit 5 is turned on in a normal time, and a colorful pattern for an advertisement of the second pattern layer unit 4 shown in FIG. 1 appears on the surface thereof by the light of the fluorescent lamp and external light.

Accordingly, the display structure body 1 functions as a general illumination advertisement panel.

Meanwhile, the light accumulation material included in the pigments 22 and 23 of the first pattern layer unit 2 is excited by the external light in a normal time.

When power supply is stopped, the fluorescent lamp 51 of the light emitting unit 5 in the display structure body 1 is turned off and external light also disappears. At that time, in a dark place, a pattern shown in FIG. 3 appears on the surface thereof by the light emitted from the light accumulation material of the first pattern layer unit 2 which is excited by the external light in a normal time. Accordingly, the display structure body 1 functions as a guide display panel for escape guide, which indicates an exit.

### Second Embodiment

FIG. 4 is a structural view showing a display structure body 1 according to a second embodiment of the present invention.

As shown in FIG. 4, the display structure body 1 according to the present embodiment includes a light transmitting first pattern layer unit 2 having a pattern made by a light accumulation material, a light transmitting second pattern layer unit 4 for normal display, which faces the first pattern layer unit 2, and a light emitting unit 5 provided on the first pattern layer unit 2 at the opposite side of the second pattern layer unit 4. That is, in comparison with the structure of the first embodiment, the positions of the first pattern layer unit and the second pattern layer unit are replaced with each other.

Even in the display structure body 1 according to the present embodiment, the same function as the first embodiment is accomplished.

### Third Embodiment

FIG. 5 is a partial enlarged cross-sectional view showing a display structure body 1 according to a third embodiment of the present invention.

As shown in FIG. 5, the display structure body 1 according to the present embodiment includes a light transmitting first pattern layer unit 2 having a pattern made by a light accumulation material, a half mirror unit 3 functioning as a light transmission restriction layer unit, a light transmitting second pattern layer unit 4 for normal display, and a light emitting unit 5, all of which are sequentially laminated from the top.

The first pattern layer unit 2 and the light emitting unit 5 are the same as those described in the first embodiment.

The second pattern layer unit 4 has a pattern for an advertisement shown in FIG. 1 and a colorful pattern is formed on the entire surface of a polyester film 41 using an ink 42 which does not transmit ultraviolet ray.

The half mirror unit 3 functioning as the light transmission restriction layer unit is formed by adhering or depositing a half mirror 31 (thin aluminum layer or thin silver layer) of average transmissivity of 20 to 30% on a film 32 made of polyester resin or polycarbonate resin.

The half mirror unit 3 functioning as the light transmission restriction layer unit blocks 70 to 80% of visible light from the light emitting unit 5 and reflects the light emitted from the light accumulation material in a dark place, thereby clearing the pattern.

The thickness of the polyester film 41 is 100 to 300 μm.

The thickness of the film 32 is 500 to 2000 μm.

The thickness of the thin aluminum layer or the thin silver layer adhered or deposited on the film 32 is 1 to 20 μm.

The ink 42 which does not transmit ultraviolet ray may be, for example, an ink mixed with an agent for absorbing ultraviolet ray (ultraviolet-ray absorption agent) and a pigment contained in the ink or a dye which absorbs ultraviolet ray.

The display structure body 1 according to the third embodiment is configured in a panel shape by sequentially laminating the second pattern layer unit 4, the half mirror unit 3, the first pattern layer unit 2 on the light emitting unit 5 and fixing the circumferences thereof by a frame 12, and is used in a state that the rear surface thereof is attached to a wall or the like.

In a normal time, the display structure body 1 is used in a state in which a fluorescent lamp 51 of the light emitting unit 5 is turned on, and a colorful pattern for an advertisement of the second pattern layer unit 4 shown in FIG. 1 appears on the surface thereof by the light of the fluorescent lamp and external light. Accordingly, the display structure body 1 functions as a general illumination advertisement panel. Meanwhile, the light accumulation material included in the pigments 22 and 23 of the first pattern layer unit 2 is excited by the external light in a normal time. At that time, since only the ink 42 which does not transmit ultraviolet ray is used, the ultraviolet ray from the light emitting unit 5 is blocked by the second pattern layer unit 4 and thus the light accumulation material of the first pattern layer unit 2 is unlikely to be excited by the light of the light emitting unit 5.

Upon the operation, 70 to 80% of the light of the light emitting unit 5 is blocked by the half mirror unit 8, but an influence is hardly exerted when a sufficiently bright fluorescent lamp of about 1900 cd/m² is used. In addition, the pattern of the second pattern layer unit 4 becomes clear by the external light.

The pattern of the first pattern layer unit 2 slightly appears by the light of the light emitting unit 5, but is hardly distinguished by the colorful pattern of the second pattern layer unit 4.

When power supply is stopped, the fluorescent lamp 51 of the light emitting unit 5 in the display structure body 1 is turned off and external light also disappears. At that time, in a dark place, a pattern shown in FIG. 3 appears on the surface thereof by the light emitted from the light accumulation material of the first pattern layer unit 2 which is excited by the external light in a normal time. Accordingly, the display structure body 1 functions as a guide display panel for escape guide, which indicates an exit.

Upon the operation, the light from the first pattern layer unit 2 passes through the half mirror unit 3 to reach the second pattern layer unit 4 and the reflected light passes through the half mirror unit 3 again to reach the first pattern layer unit 2. Since the light passes through the half mirror unit 3 twice, the amount of the light is reduced to 4% and thus the pattern of the second pattern layer unit 4 hardly appears on the surface thereof.

In addition, since the light of the first pattern layer unit 2 is reflected by the half mirror unit 3, the pattern of the first pattern layer unit 2 clearly appears. As described above, since the light accumulation material of the first pattern layer unit 2 is unlikely to be excited by the light of the light emitting unit 5 in a normal time, the pattern of the first pattern layer unit 2 becomes clear.

When the pattern of the second pattern layer unit 4 is formed using an ink which transmits ultraviolet ray and an ink which does not transmit ultraviolet ray, the excitation degree of the light accumulation material of the first pattern layer unit 2 corresponding to the pattern formed of the ink which transmits ultraviolet ray increases. As a result, an irregularity may occur in the pattern of the first pattern layer unit 2 which appears in a dark place, but this problem is solved by using the ink 42 which does not transmit ultraviolet ray.

The ink which transmits ultraviolet ray indicates an ink that, when an ink layer (generally, 20 to 50 μm) is formed, the ink layer transmits light having a wavelength of less than 400 nm by at least 10%. The ink which does not transmit ultraviolet ray may be, for example, an ink mixed with an ultraviolet-ray absorption agent and indicates an ink that, when an ink layer (generally, 20 to 50 μm) is formed, the ink layer blocks light having a wavelength of less than 400 nm by at least 10% and more particularly at least 90%. The measurement is performed by a reflection absorption spectrum device.

As the ink, an ink for an inkjet print which is commercially available may be used.

### Fourth Embodiment

A fourth embodiment has the same configuration as the third embodiment except that an ink which transmits ultraviolet ray is used as an ink for forming the pattern of a second pattern layer unit 4.

Accordingly, since the ultraviolet ray from the light emitting unit 5 transmits entirely through the second pattern layer unit 4 to reach a first pattern layer unit 2, the light accumulation material of the first pattern layer unit 2 is entirely excited and thus an irregularity does not occur in the pattern of the first pattern layer unit 2, similar to the third embodiment. In addition, since the light accumulation material of the first pattern layer unit 2 is excited by the light from the light emitting unit 5, the light emission display of the first pattern layer unit 2 becomes clearer than that of the third embodiment, in a dark place.

### Fifth Embodiment

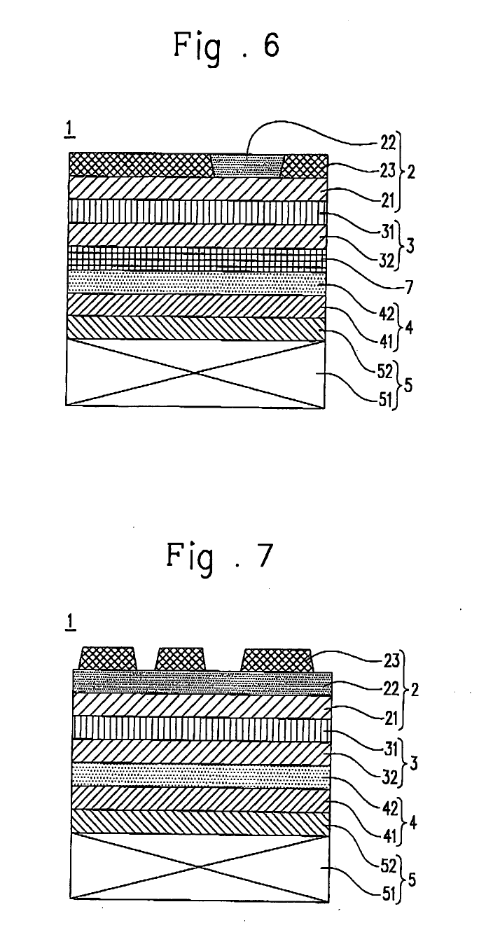

FIG. 6 is a partial enlarged cross-sectional view showing a display structure body 1 according to a fifth embodiment of the present invention.

As shown in FIG. 6, in the display structure body 1 according to the fifth embodiment, an ultraviolet-ray absorption film 7 for absorbing ultraviolet ray is interposed between a half mirror unit 3 and a second pattern layer unit 4. By this configuration, the ultraviolet ray from the light emitting unit 5 is prevented from being transmitted to prevent an irregularity from occurring in the pattern of a first pattern layer unit 2 which appears in a dark place, similar to the third embodiment.

According to this configuration, an ink which transmits light having a proper wavelength can be freely used as an ink for forming the second pattern layer unit 4 and thus a pattern having excellent design feature can be formed in the second pattern layer unit 4.

As the ultraviolet-ray absorption film, for example, an ultraviolet-ray absorption film mixed with an ultraviolet-ray absorption agent commercially available can be used.

The ultraviolet-ray absorption film absorbs light having a wavelength of less than 400 nm by at least 10% and more particularly at least 90%.

### Sixth Embodiment

FIG. 7 is a partial enlarged cross-sectional view showing a display structure body 1 according to a sixth embodiment of the present invention.

As shown in FIG. 7, the display structure body 1 according to the sixth embodiment includes a light transmitting first pattern layer unit 2 having a pattern made by a light accumulation material, a half mirror unit 8 as a light transmission restriction layer unit, a light transmitting second pattern layer unit 4, and a light emitting unit 5 on a material layer having a short wavelength light absorption function, all of which are sequentially laminated from the top.

In the sixth embodiment, in consideration that the light accumulation material is likely to be excited by light having a wavelength of less than 400 nm such as purple colored light or ultraviolet ray, in order to prevent an irregularity in brightness from occurring in the pattern of the first pattern layer unit 2, a light transmitting layer made of a material for absorbing ultraviolet ray is provided below the pattern made of the light accumulation material of the first pattern layer unit 2. Accordingly, the light transmitting layer absorbs the ultraviolet ray from the light emitting unit 5 to prevent the ultraviolet ray from reaching the pattern of the light accumulation material and to prevent an irregularity in brightness from occurring in the pattern of the light accumulation material of the first pattern layer unit 2 in a dark place.

The material layer having the short wavelength light absorption function indicates a layer which absorbs light having a wavelength of less than 400 nm by at least 10% and more preferably at least 90% and transmits the rest of light.

As the light transmitting material having the short wavelength light absorption function, for example, a fluorescent material can be used.

As the fluorescent material, a white organic or inorganic material can be used. For example, “Invisible Blue (name of commodity)” made by Diglo Corporation may be used.

If the above fluorescent material is used, the following effect is obtained. That is, even when the layer made of the material for absorbing ultraviolet ray is provided below the pattern of the light accumulation material, an irregularity in brightness may slightly occur.

This seems to be because ultraviolet ray eventually transmits slightly even in either case or the light accumulation material is slightly excited by light having a wavelength other than ultraviolet ray.

Although the irregularity in brightness occurs, when the fluorescent material is used, the light from the light accumulation material diffuses by fluorescent material particles and the diffused light reaches the light accumulation material again. Accordingly, a dark portion becomes bright and the irregularity in brightness disappears in a short time.

In the sixth embodiment, as shown in FIG. 3, the first pattern layer unit 2 has a pattern for displaying an exit. The pattern is formed by printing an ink layer 22 mixed with the fluorescent material on the entire surface of a film 21 made of polyester resin or polycarbonate resin and printing thereon an ink pattern 23 mixed with the light accumulation material for emitting green light. The pattern is formed by providing the ink pattern 23 mixed with the light accumulation material and having a white turbidity state on the ink layer 22 mixed with the fluorescent material and having a white turbidity state. Accordingly, the entire surface of the first pattern layer unit 2 is in a white turbidity state and thus the pattern is unlikely to be recognizable in a bright place in a normal time. In addition, only an escape guide mark portion such as an arrow for indicating an exit or an escape direction may be formed with an ink mixed with the light accumulation material or a portion other than the escape guide mark portion such as the arrow for indicating the exit or the escape direction may be formed with an ink mixed with the light accumulation material.

As vehicles of the inks of the ink layer 22 and the ink pattern 23, UV curing or heating/drying/curing acrylic resin or epoxy resin is used, and the vehicles are mixed with a fluorescent material having a concentration of 0.5 to 20 wt % and a light accumulation material having a concentration of 5 to 25 wt %. The second pattern layer unit 4, the half mirror unit 3, and the light emitting unit 5 are the same as those described above.

The display structure body 1 according to the sixth embodiment is configured in a panel shape by sequentially laminating the second pattern layer unit 4, the half mirror unit 3, and the first pattern layer unit 2 on the light emitting unit 5 and fixing the circumferences thereof by a frame 12, and is used in a state that the rear surface thereof is attached to a wall or the like.

In a normal time, the display structure body 1 according to the sixth embodiment is used in a state that a fluorescent lamp 51 of the light emitting unit 5 is turned on, and a colorful pattern for an advertisement of the second pattern layer unit 4 shown in FIG. 1 appears on the surface thereof by the light of the fluorescent lamp and external light. Accordingly, the display structure body 1 functions as a general illumination advertisement panel. Meanwhile, in a normal time, the light accumulation material included in the ink pattern 23 of the first pattern layer unit 2 is excited by the external light. In addition, since the ink layer 22 mixed with the fluorescent material is provided below the ink pattern 23, the ultraviolet ray which transmits through the second pattern layer unit 4 from the light emitting unit 5 is almost absorbed by the ink layer 22 and thus the light accumulation material included in the ink pattern 23 of the first pattern layer unit 2 is unlikely to be excited by the ultraviolet ray from the light emitting unit 5.

Upon the operation, 70 to 80% of the light of the light emitting unit 5 is blocked by the half mirror unit 3, but an influence is hardly exerted when a sufficiently bright fluorescent lamp of about 1900 cd/m² is used. In addition, the pattern of the second pattern layer unit 4 becomes clear by being additionally irradiated by the external light. The pattern of the first pattern layer unit 2 slightly appears by the light of the light emitting unit 5, but is hardly distinguished by the colorful pattern of the second pattern layer unit 4.

When power supply is stopped, the fluorescent lamp 51 of the light emitting unit 5 in the display structure body 1 is turned off and external light also disappears. At that time, in a dark place, a pattern shown in FIG. 3 appears on the surface thereof by the light emitted from the light accumulation material of the ink pattern 23 of the first pattern layer unit 2 which is excited by the external light in a normal time. Accordingly, the display structure body 1 functions as a guide display panel for escape guide, which indicates an exit.

Upon the operation, the light from the first pattern layer unit 2 passes through the half mirror unit 3 to reach the second pattern layer unit 4 and the reflected light passes through the half mirror unit 3 again to reach the first pattern layer unit 2. Since the light passes through the half mirror unit 3 twice, the amount of the light is reduced to 4% to 9% and thus the pattern of the second pattern layer unit 4 hardly appears on the surface thereof. In addition, since the light of the first pattern layer unit 2 is reflected by the half mirror unit 3, the pattern of the first pattern layer unit 2 also clearly appears.

As described above, since the light accumulation material included in the ink pattern 23 of the first pattern layer unit 2 is unlikely to be excited by the light of the light emitting unit 5 in a normal time, the pattern of the first pattern layer unit 2 becomes clear.

That is, if the pattern of the second pattern layer unit 4 is formed with inks of various colors such that an ink portion which transmits ultraviolet ray and an ink portion which does not transmit ultraviolet ray are included in the pattern, the ultraviolet ray which passes through only the ink portion which transmits the ultraviolet ray reaches the first pattern layer unit 2.

Accordingly, when the ink layer 22 is not included in the first pattern layer unit 2, the excitation degree of the light accumulation material of the pattern of the ink pattern 23 of the first pattern layer unit 2 corresponding to the pattern of the second pattern layer unit 4 formed by the ink which transmits the ultraviolet ray becomes higher than that of the peripheral light accumulation material. As a result, an irregularity in brightness occurs in the pattern of the first pattern layer unit 2 which appears in a dark place as a ghost, which makes the pattern of a dark portion hard to be seen, and an appearance is deteriorated. This problem is solved by providing the ink layer 22 mixed with the fluorescent material for absorbing the ultraviolet ray below the ink pattern 23 mixed with the light accumulation material in the first pattern layer unit 2 such that the ultraviolet ray is absorbed by the ink layer 22 to be prevented from reaching the ink pattern 23.

Even in the above configuration, the ghost may slightly occur in the ink pattern 23. This seems to be because ultraviolet ray transmits slightly even in either case or the light accumulation material of the ink pattern 23 is slightly excited by light having a wavelength other than ultraviolet ray. However, it is experimentally confirmed that the ghost disappears in a short time after the light emission of the light accumulation material starts due to the existence of the ink layer 22 mixed with the fluorescent material. This seems to be because fluorescent material particles are included in the ink layer 22, the light from the light accumulation material of the ink pattern 23 diffuses by the fluorescent material particles, and the diffused light reaches the ink pattern 23 directly or by the mirror reflection of the half mirror unit 3 such that a ghost portion of the ink pattern 23 becomes bright.

The light accumulation material is slightly excited even by light having a wavelength of 400 nm to 450 nm other than the ultraviolet ray.

### Seventh Embodiment

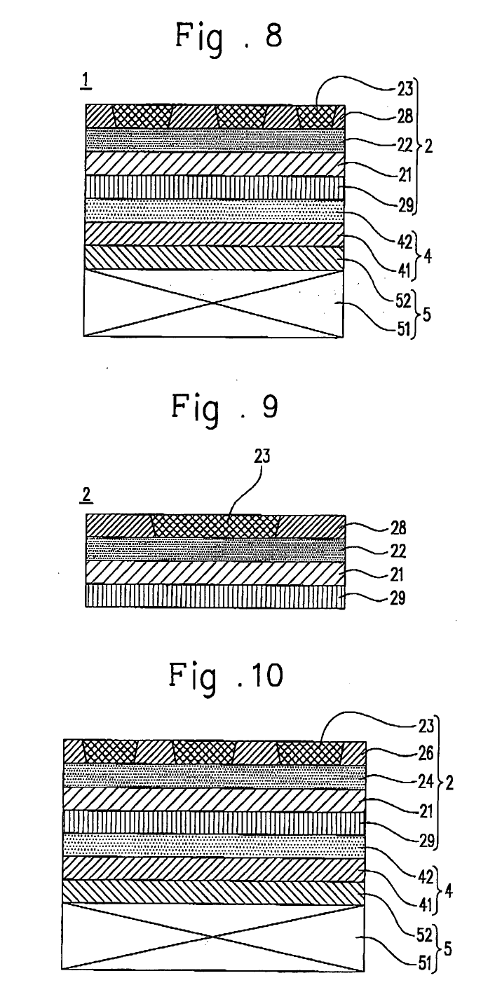

FIG. 8 is a partial enlarged cross-sectional view showing a display structure body 1 according to a seventh embodiment of the present invention.

FIG. 9 is an enlarged cross-sectional view showing a first pattern layer unit 2 of the display structure body 1 according to the seventh embodiment of the present invention.

As shown in FIG. 8, the display structure body 1 according to the seventh embodiment includes a first pattern layer unit 2, a second pattern layer unit 4, and a light emitting unit 5, all of which are sequentially laminated from the top.

In the seventh embodiment, as shown in FIG. 9, an pattern for displaying an exit is formed on the first pattern layer unit 2 by printing a first ink layer 22 mixed with a fluorescent material on the entire surface of a film 21 made of polyester resin or polycarbonate resin, printing a second ink layer 28 mixed with a fluorescent material in a portion except for the above pattern forming portion, and printing an ink pattern 23 mixed with a light accumulation material for emitting green light or the like in the pattern forming portion formed in a concave state, thereby forming the pattern as shown in FIG. 9.

The pattern is formed by providing the ink pattern 23 mixed with the light accumulation material and having a white turbidity state on the ink layers 22 and 28 mixed with the fluorescent material and having a white turbidity state. Accordingly, the entire surface of the first pattern layer unit 2 is in a white turbidity state and thus the pattern of the ink pattern 23 is unlikely to be distinguished in a bright place in a normal tine. In addition, as described below, the concentrations of the inks of the fluorescent material and the light accumulation material are adjusted such that a portion in which the ink pattern 23 is formed and the other portion have the same transmissivity and thus the pattern of the ink pattern 23 is unlikely to be distinguished in a bright place in a normal time.

As vehicles of the inks of the ink layers 22 and 28 and the ink pattern 23, UV curing or heating/drying/curing acrylic resin or epoxy resin is used. The ink layer 22 has a thickness of 20 to 50 μm and uses an ink mixed with a fluorescent material of 0.5 to 20 wt % as the vehicle, the ink layer 28 has a thickness of 20 to 50 μm and uses an ink mixed with a fluorescent material of 10 to 40 wt % as the vehicle, and the ink pattern 23 has a thickness of 20 to 50 μm and uses an ink mixed with a fluorescent material of 10 to 30 wt % as the vehicle.

A half mirror 29 functioning as a light transmission restriction layer made of an aluminum layer or a silver layer is integrally provided on the rear surface of the film 21. The half mirror 29 averagely transmits visible light of 400 to 700 nm by 20 to 30% as transmissivity and is integrally provided on the film 21 by adhering or depositing a thin film.

The second pattern layer unit 4 has a pattern for an advertisement as shown in FIG. 1 and a colorful pattern is formed on an achromatic transparent polyester film 41 or the like by an ink 42 of proper color. The light emitting unit 5 is the same as that described above.

The display structure body 1 according to the seventh embodiment is configured in a panel shape by sequentially laminating the second pattern layer unit 4 and the first pattern layer unit 2 on the light emitting unit 5 and fixing the circumferences thereof by a frame 12, and is used in a state that the rear surface thereof is attached to a wall or the like.

In a normal time, the display structure body 1 according to the seventh embodiment is used in a state that a fluorescent lamp 51 of the light emitting unit 5 is turned on, and a colorful pattern for an advertisement of the second pattern layer unit 4 shown in FIG. 1 appears on the surface thereof by the light of the fluorescent lamp and external light. Accordingly, the display structure body 1 functions as a general internal illumination advertisement panel.

Meanwhile, in a normal time, the light accumulation material included in the ink pattern 23 of the first pattern layer unit 2 is excited by the light of the light emitting unit 5 and the external light. In addition, since the ink layer 22 mixed with the fluorescent material is provided below the ink pattern 23, 90% of the ultraviolet ray which transmits through the second pattern layer unit 4 from the light emitting unit 5 is absorbed by the ink layer 22 and thus the excitation of the light accumulation material included in the ink pattern 23 of the first pattern layer unit 2 is suppressed to some extent by the ultraviolet ray from the light emitting unit 5.

Upon the operation, 70 to 80% of the light of the light emitting unit 5 is blocked by the half mirror 29, but an influence is hardly exerted when a sufficiently bright fluorescent lamp of about 1900 cd/m² is used. In addition, the pattern of the second pattern layer unit 4 becomes clear by being additionally irradiated by the external light. The pattern of the first pattern layer unit 2 also slightly appears by the light of the light emitting unit 5, but is hardly distinguished by the colorful pattern of the second pattern layer unit 4. As described above, since the ink pattern 23 mixed with the light accumulation material and having a white turbidity state is provided on the ink layers 22 and 28 mixed with the fluorescent material and having a white turbidity state and the concentrations of the inks of the fluorescent material and the light accumulation material are adjusted, the pattern of the first pattern layer unit 2 is unlikely to be distinguished in a bright place in a normal time. In addition, the ink pattern 23 is printed in a pattern forming portion formed by the ink layer 28 in a concave state and the surface of the ink layer 28 is flush with the surface of the ink pattern 23, thereby preventing the ink pattern 23 from being protruded and hence distinguished.

When power supply is stopped, a fluorescent lamp 51 of the light emitting unit 5 in the display structure body 1 is turned off and external light also disappears. At that time, in a dark place, a pattern shown in FIG. 3 appears on the surface thereof by the light emitted from the light accumulation material of the ink pattern 23 of the first pattern layer unit 2 which is excited by the light of the light emitting unit 5 and the external light in a normal time. Accordingly, the display structure body 1 functions as a guide display panel for escape guide, which indicates an exit.

Upon the operation, the light from the first pattern layer unit 2 passes through the half mirror 29 to reach the second pattern layer unit 4 and the reflected light passes through the half mirror 29 again to reach the first pattern layer unit 2. Since the light passes through the half mirror 29 twice, the amount of the light is reduced to 4% to 9% and thus the pattern of the second pattern layer unit 4 hardly appears on the surface thereof by the reflected light.

In addition, since the light of the first pattern layer unit 2 is reflected by the half mirror 29, the pattern of the first pattern layer unit 2 also clearly appears.

As described above, since the light accumulation material included in the ink pattern 23 of the first pattern layer unit 2 is suppressed from being excited by the ultraviolet ray of the light emitting unit 5 in a normal time, the pattern of the first pattern layer unit 2 becomes clear.

That is, if the pattern of the second pattern layer unit 4 is formed with inks of various colors such that an ink portion which transmits ultraviolet ray and an ink portion which does not transmit ultraviolet ray are included in the pattern, the ultraviolet ray which passes through only the ink portion which transmits the ultraviolet ray reaches the first pattern layer unit 2.

Accordingly, when the ink layer 22 is not included in the first pattern layer unit 2, the excitation degree of the light accumulation material of the pattern of the ink pattern 23 of the first pattern layer unit 2 corresponding to the pattern of the second pattern layer unit 4 formed by the ink which transmits the ultraviolet ray becomes higher than that of the peripheral light accumulation material. As a result, an irregularity in brightness occurs in the pattern of the first pattern layer unit 2 which appears in a dark place, that is, a ghost occurs, and an appearance is deteriorated.

This problem is solved by providing the ink layer 22 mixed with the fluorescent material for absorbing the ultraviolet ray below the ink pattern 23 mixed with the light accumulation material in the first pattern layer unit 2 such that the ultraviolet ray is absorbed by the ink layer 22 to be prevented from reaching the ink pattern 23.

Even in the above configuration, the ghost may slightly occur in the ink pattern 23. This seems to be because light of ultraviolet ray (less than 400 nm) transmits slightly even in either case or the light accumulation material of the ink pattern 23 is slightly excited by light having a wavelength of 400 to 450 nm, which is not absorbed by the ink layer 22.

However, it is experimentally confirmed that the ghost disappears in a short time after the light emission of the light accumulation material starts due to the existence of the ink layers 22 and 28 mixed with the fluorescent material. This seems to be because fluorescent material particles are included in the ink layers 22 and 28, the light from the light accumulation material of the ink pattern 23 diffuses by the fluorescent material particles, and the diffused light reaches the ink pattern 23 directly or by the mirror reflection of the half mirror 29 such that a ghost portion of the ink pattern 23 becomes uniform.

### Eighth Embodiment

The eighth embodiment has the same configuration as the seventh embodiment. FIG. 10 is a partial enlarged cross-sectional view showing a display structure body 1 according to an eighth embodiment of the present invention.

As shown in FIG. 10, in the display structure body 1 according to the eighth embodiment, the surface of a film 21 of a first pattern layer unit 2 is coated with ink layers 24 and 26 mixed with white inorganic powder, similar to the ink layers 22 and 28 of the seventh embodiment, an ink pattern 23 made of a light accumulation material is formed, and an ink which transmits ultraviolet ray or does not transmit ultraviolet ray is used as an ink 42 for forming the pattern of the entire surface of a second pattern layer unit 4.

As the white inorganic powder, calcium carbonate may be used although not specially limited. In a normal time, the ink pattern 23 of the first pattern layer unit 2 is entirely excited or not entirely excited such that the excitation degree of the ink pattern 23 of the first pattern layer unit 2 becomes uniform. Thus, an irregularity does not occur in the pattern of the first pattern layer unit 2 in a dark place. By providing the ink layers 24 and 26, it is difficult to recognize the pattern of the first pattern layer unit 2 in a bright place in a normal time, similar to the seventh embodiment. In addition, it is possible to prevent the ink pattern 23 from being protruded and distinguished.

### Ninth Embodiment

The ninth embodiment has the same configuration as the seventh embodiment except that the patterns of a first pattern layer unit 2 and a second pattern layer unit 4 are different from each other.

FIG. 11 is a pattern view showing a first pattern layer unit and a second pattern layer unit of a display structure body 1 according to a ninth embodiment of the present invention.

As shown in FIG. 11, an escape guide is formed in a first pattern layer unit 2 and an advertisement is formed in a second pattern layer unit 4.

Accordingly, in the first pattern layer unit 2, an ink pattern 23 mixed with a light accumulation material is formed only in a middle space (space between dotted lines) S1 to guide to an exit. On the other hand, a pattern is formed on a transparent resin surface of the middle space S1 of the second pattern layer unit 4 by a violet or dark blue ink 42 and patterns are formed on an upper space S2 and a lower space S3 by an ink 42 of any color.

The first pattern layer unit 2 and the second pattern layer unit 4 are combined to configure the display structure body 1 and thus the light which passes through the middle space S1 of the second pattern layer unit 4 from the light emitting unit 5 becomes light which is apt to excite the light accumulation material having a wavelength of 400 to 450 nm. Accordingly, in a normal time, the light accumulation material included in the ink pattern 23 of the first pattern layer unit 2 is efficiently excited by ultraviolet ray.

That is, the light accumulation material is excited by light having a wavelength of about 450 nm. Since the ninth embodiment uses the fluorescent material similar to the seventh embodiment, ultraviolet ray having a wavelength of less than 400 nm is blocked, but light having other wavelength is not blocked. Accordingly, when the middle space of the second pattern layer unit is transparent or violet or dark blue, the light which passes through the middle space becomes light having a wavelength of 400 to 450 nm.

As a result, when power supply is stopped, the ink pattern 23 entirely and brightly emits light to perform a display and a ghost is prevented from occurring.

Meanwhile, in the second pattern layer unit 4, the pattern of the spaces except for the middle space SI are formed using an ink of any color so as to realize a pattern having an excellent advertisement function.

When the pattern of the second pattern layer unit 4 is designed and manufactured in correspondence with the pattern of the first pattern layer unit 2 known previously, an ink 42 of such as red, yellow, green or black may be used at a position which does not correspond to the ink pattern 23 of the first pattern layer unit 2 without setting the above space.

In addition, when it is determined that the display of the ink pattern 23 of the first pattern layer unit 2 is not damaged even by the occurrence of a slight ghost, an ink 42 of such as red, yellow, green or black may be used even at the position corresponding to the ink pattern 23 of the first pattern layer unit 2.

As described above, according to the present embodiment, an advertisement display can be performed in a normal time and a bright clear escape display can be performed when power supply is stopped.

### Tenth Embodiment

Although the half mirror unit 3 is laminated between the first pattern layer unit 2 and the second pattern layer unit 4 in the third embodiment to the ninth embodiment, the half mirror unit 3 may be laminated between the second pattern layer unit 4 and the light emitting unit 5.

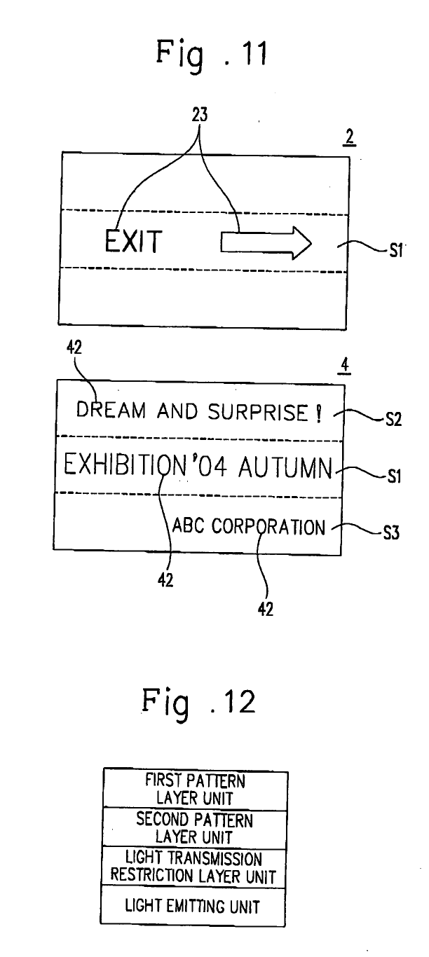

FIG. 12 is a structural view showing a display structure body I according to a tenth embodiment of the present invention.

As shown in FIG. 12, the display structure body I according to the tenth embodiment includes a light transmitting first pattern layer unit 2 having a pattern made by a light accumulation material, a light transmitting second pattern layer unit 4 for normal display, a half mirror unit 3 functioning as a light transmission restriction layer unit, and a light emitting unit 5, all of which are sequentially laminated from the top.

Even in this configuration, it is possible to obtain a display structure body which has a normal display function such as an advertisement in a normal time, and is automatically switched to a display of escape guide when power supply is stopped.

Next, a modified embodiment of the second embodiment will be described. As shown in FIG. 4, the display structure body 1 according to the second embodiment includes a light transmitting first pattern layer unit 2 having a pattern made by a light accumulation material, a light transmitting second pattern layer unit 4 for normal display, which faces the first pattern layer unit 2, and a light emitting unit 5 provided on the first pattern layer unit 2 at the opposite side of the second pattern layer unit 4.

### Eleventh Embodiment

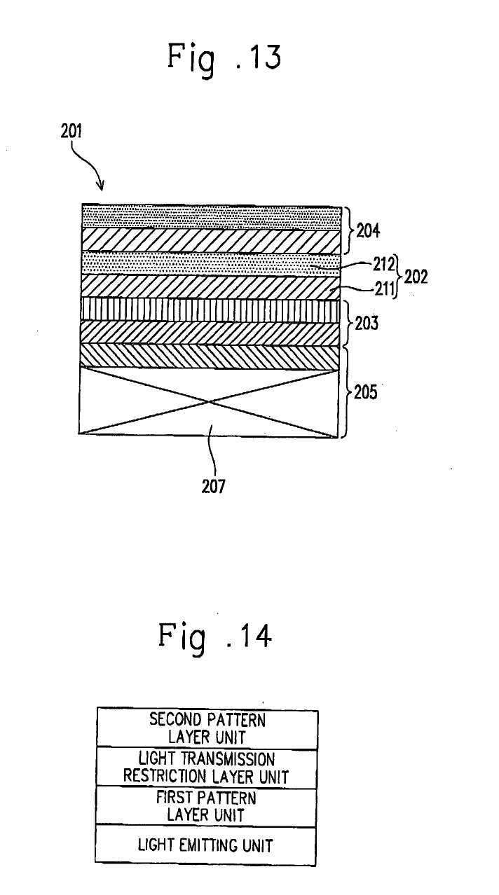

FIG. 13 is a partial enlarged cross-sectional view showing a display structure body 201 according to an eleventh embodiment of the present invention.

As shown in FIG. 13, the display structure body 201 according to the eleventh embodiment includes a light transmitting second pattern layer unit 204 for normal display, a light transmitting first pattern layer unit 202 having a pattern made by a light accumulation material, a half mirror unit 203 functioning as a light transmission restriction layer unit, and a light emitting unit 205, all of which are sequentially laminated from the top.

The first pattern layer unit 202 has a pattern for escape and a pattern is formed by printing an ink pattern 212 mixed with a light accumulation material for emitting green light or the like on a film 211 made of polyester resin or polycarbonate resin.

The second pattern layer unit 204, the half mirror unit 203 functioning as the light transmission restriction layer unit, and the light emitting unit 205 are the same as those described above.

In a normal time, the display structure body 201 according to the eleventh embodiment is used in a state that a fluorescent lamp 207 of the light emitting unit 205 is turned on, and a pattern for an advertisement of the second pattern layer unit 204 of the surface thereof appears by the light of the fluorescent lamp and external light. Accordingly, the display structure body 201 functions as a general illumination advertisement panel. In a normal time, the light accumulation material included in the ink pattern 212 of the first pattern layer unit 202 is excited by the external light and the light of the light emitting unit 205.

Upon the operation, 70 to 80% of the light of the light emitting unit 205 is blocked by the half mirror unit 203, but an influence is hardly exerted when a sufficiently bright fluorescent lamp of about 1900 cd/M² is used. In addition, the pattern of the second pattern layer unit 204 becomes clear by being additionally radiated by the external light. The pattern of the first pattern layer unit 202 slightly appears by the light of the light emitting unit 205, but is hardly distinguished.

When power supply is stopped, the fluorescent lamp 207 of the light emitting unit 205 in the display structure body 201 is turned off and external light also disappears. At that time, in a dark place, a pattern shown in FIG. 3 appears on the surface of the second pattern layer unit 204 by the light emitted from the light accumulation material of the ink pattern 212 of the first pattern layer unit 202 which is excited by the external light and the light of the light emitting unit 205 in a normal time. Accordingly, the display structure body 201 functions as a guide display panel for escape guide, which indicates an exit.

The pattern of the escape guide has the color pattern of the second pattern layer unit 204, but an escape guide function is sufficiently accomplished. Since the color pattern of the second pattern layer unit 204 does not use color having inferior transmissivity such as black, the escape guide pattern can become bright and clear.

### Twelfth Embodiment

Although the half mirror unit is laminated between the first pattern layer unit and the light emitting unit in the eleventh embodiment, the half mirror unit may be laminated between the second pattern layer unit and the first pattern layer unit.

FIG. 14 is a structural view showing a display structure body 1 according to a twelfth embodiment of the present invention.

As shown in FIG. 14, the display structure body according to the twelfth embodiment includes a light transmitting second pattern layer unit for normal display, a half mirror unit functioning as a light transmission restriction layer unit, a light transmitting first pattern layer unit having a pattern made by a light accumulation material, and a light emitting unit, all of which are sequentially laminated from the top.

Even in this configuration, it is possible to obtain a display structure body which has a general display function such as an advertisement in a normal time, and is automatically switched to a display of escape guide when power supply is stopped.

Next, a light emitting display body which includes a light transmitting first pattern layer unit having a pattern made by a light accumulation material and a light transmission restriction layer unit provided at the rear surface side of the first pattern layer unit, and is mounted on the surface of an illumination display body for use will be described.

The rear surface side of the first pattern layer unit indicates the opposite side of a display surface attached with the pattern made by the light accumulation material.

Since the first pattern layer unit and the light transmission restriction layer unit are integrally formed in the light emitting display body, it is possible to easily obtain a display structure body by mounting the light emitting display body on the entire surface of a general internal illumination advertisement panel.

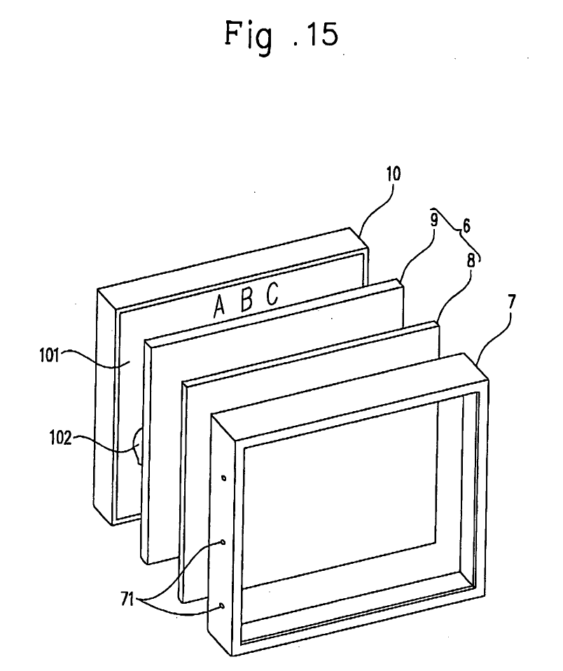

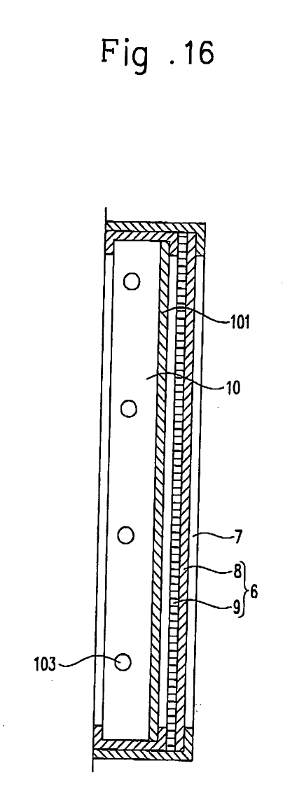

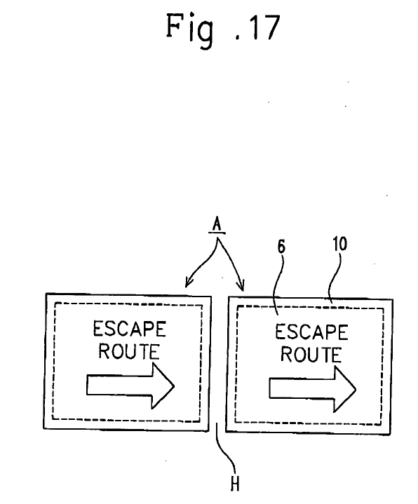

FIG. 15 is an exploded perspective view showing a display structure body in which a light emitting display body is mounted, FIG. 16 is a vertical cross-sectional view showing the use state of a display structure body in which a light emitting display body is mounted, and FIG. 17 is an explanatory view showing the display state thereof.

The light emitting display body 6 includes a pattern layer member 8 made of a light accumulation material and a half mirror unit 9 functioning as a light transmission restriction member provided at the rear surface side of the pattern layer member 8, and an attachment frame 7 is fitted and mounted from the front side in a state in which the pattern layer member 8 and the half mirror unit 9 are laminated on the surface of an illumination advertisement panel 10 functioning as an illumination display body. The attachment is performed by bringing a fixing screw into threaded engagement with a threaded hole 71 of the side surface of the attachment frame 7 and pressing and fixing the front end of the screw on the side surface of the illumination advertisement panel 10.

As described above, the display structure body is configured by attaching the light emitting display body 6 on the surface of the illumination advertisement panel 10. That is, the pattern layer member 8 and the half mirror unit 9 respectively correspond to the first pattern layer unit 2 and the half mirror unit 3 of the display structure body 1, the advertisement pattern 102 on the surface of the surface plate 101 of the illumination advertisement panel 10 corresponds to the second pattern layer unit 4, and the other portion of the illumination advertisement panel 10 corresponds to the light emitting unit 5.

The ink used for forming the advertisement pattern 102 is properly selected in association with a function for transmitting ultraviolet ray.

An ultraviolet absorption film is integrally adhered to the rear surface of the half mirror unit 9 to obtain the configuration of the display structure body 1 according to the fifth embodiment.

The light emitting display unit 6 is mounted in the existing illumination advertisement panel 10 for use.

For example, as shown in FIG. 17, at a wall H of an underground arcade or the platform of a station, a plurality of large-sized illumination advertisement panels 10 are successively provided and light emitting display bodies 6 are attached thereto.

When surroundings in a normal time are bright and the fluorescent lamp 103 of the illumination advertisement panel 10 is turned on even in a state in which the light emitting display body 6 is mounted, the advertisement pattern 102 of the illumination advertisement panel 10 appears on the surface of the pattern layer member 8, substantially similar to a case where the light emitting display body 6 is not mounted.

In contrast, when power supply is stopped, that is, when peripheral illuminations are turned off and the fluorescent lamp 103 of the illumination advertisement panel 10 is also turned off to get dark, the display contents formed by the light accumulation material appears on the surface of the pattern layer member 8. By mounting the light emitting display bodies 6 respectively on the plurality of large-sized illumination advertisement panels 1 provided successively, a display A of escape guide shown in FIG. 17 is formed on the wall.

Even when power supply is stopped and disturbance feeling is caused due to disaster, an escape activity may become smooth by the display of escape guide and thus safety property is more excellent than the conventional art in disaster or the like.

### INDUSTRIAL AVAILABILITY

It is possible to provide a display structure body which has a general display function such as an advertisement in a normal time, and is automatically switched to a display of escape guide when power supply is stopped.

What is claimed is

1. A display structure body comprising a light transmitting first pattern layer unit having a pattern made by a light accumulation material and a light transmitting second pattern layer unit for normal display, on the surface of a light emitting unit.

2. A display structure body comprising a light transmitting first pattern layer unit having a pattern made by a light accumulation material, a light transmitting second pattern layer unit for normal display, a light transmission restriction layer unit provided between the first pattern layer unit and the second pattern layer unit, and a light emitting unit provided on the second pattern layer unit at the opposite side of the light transmission restriction layer.

3. A display structure body comprising a light transmitting first pattern layer unit having a pattern made by a light accumulation material, a light transmitting second pattern layer unit for normal display, a light transmission restriction layer unit provided between the first pattern layer unit and the second pattern layer unit, and a light emitting unit provided on the second pattern layer unit at the opposite side of the light transmission restriction layer, on a material layer having a short-wavelength light absorption function.

4. A display structure body comprising a light transmitting first pattern layer unit having a pattern made by a light accumulation material, a light transmitting second pattern layer unit for normal display, which faces the first pattern layer unit, a light transmission restriction layer unit provided on the first pattern layer unit at the opposite side of the second pattern layer unit, and a light emitting unit provided on the light transmission restriction layer at the opposite side of the first pattern layer unit.

5. A light emitting display body comprising a light transmitting first pattern layer unit having a pattern made by a light accumulation material and a light transmission restriction layer unit provided on the rear surface of the first pattern layer unit, wherein the light emitting display body is mounted on the surface of an illumination display body.
